(19) United States
(12) Patent Application Publication
(10) Pub. No.: US 2008/0105856 A1
(43) Pub. Date: May 8, 2008

(54) Color fast aromatic polyurethanes

(76) Inventors: Tapan K. DebRoy, Avondale, PA (US); Michael Christopher Weismiller, Hockessin, DE (US); Matthew Todd Bonk, Newark, DE (US)

Correspondence Address: JoAnn Villamizar;Ciba Corporation/Patent Department, 540 White Plains Road, P.O. Box 2005, Tarrytown, NY, 10591, US

(21) Appl. No.: 11/975,095

(22) Filed: Oct. 17, 2007

Related U.S. Application Data
(60) Provisional application No. 60/854,305, filed on Oct. 25, 2006.

(51) Int. Cl. G02B 5/00

(52) U.S. Cl. 252/589

(57) ABSTRACT

Color fast or non-yellowing aromatic polyurethane compositions comprising a combination of certain benzotriazole ultraviolet light absorbers and hindered amine light stabilizer and a method for maintaining the color fastness of aromatic polyurethane compositions by incorporating the ultraviolet light absorber and hindered amine light stabilizer into an aromatic polyurethane composition are provided.

This application claims benefit under 35 USC 119(e) of U.S. provisional application No. U.S. Ser. No. 60/854,305 filed Oct. 24, 2006.

Compositions comprising an aromatic polyurethane and a mixture of certain UVAs and HALS are highly resistant to yellowing or discoloration upon exposure to UV light.

Polyurethanes are well known resins used in a wide variety of commercial applications. Thermoplastic, elastomeric, thermoset, linear and crosslinked polyurethanes are all known. Both aliphatic polyurethanes, i.e., polymers formed from the reaction of aliphatic isocyanates or isocyanurates with diols or polyols, and aromatic polyurethanes, i.e., polymers formed from the reaction of aromatic isocyanates or isocyanurates with diols or polyols, are known and each type of polyurethane possesses its own advantages and disadvantages. One particular disadvantage of aromatic polyurethanes is their extreme sensitivity to light, in particular UV light but visible light can also be detrimental.

As with many polymer systems, the use of light stabilizers, e.g., hindered amine light stabilizers (HALS) and Ultraviolet Light Absorbers (UVAs), to protect urethane polymers from the deleterious effects of sunlight is well known. UVAs include, but are not limited to, hydroxyphenylbenzotriazoles, benzophenones, benzoxazones, α-cyanoacrylates, oxanilides, tris-aryl-s-triazines, formamidines, cinnamates, malonates, benzilidenes, salicylate and benzoate UVAs and resorcinol and phenol esters of terephthalic and isophthalic acid.

Whereas commercially available light stable formulations of aliphatic polyurethanes are common, aromatic polyurethanes are extremely sensitive to light and readily yellow upon exposure to sunlight under ambient conditions. Obtaining a non-yellowing, or non-discoloring, light stable formulation of an aromatic polyurethane has proven extremely difficult.

U.S. Pat. No. 5,785,916, incorporated herein in its entirety by reference, discloses a process for improving the UV and heat stability of thermoplastic polyurethanes by incorporating into a polyurethane composition one or more acrylate based rubbers and one or more UV and/or heat stabilizers. Preferred as UV stabilizers are benzotriazole UV absorbers but hindered amine light stabilizers are also disclosed.

U.S. Pat. No. 5,840,788, incorporated herein in its entirety by reference, discloses a golf ball coated with an outer layer comprising an aliphatic urethane and a mixture of UVA, HALS and fluorescent whitener (FWA). The FWA is present in part to absorb light in the near UV that is not typically absorbed by the UVA. Preferred are triazine UVAs and as the HALS, 3-dodecyl-1-(2,2,6,6-tetramethylpiperidinyl)-2,5-pyrrolidinedione is preferred.

U.S. Pat. No. 5,156,405, incorporated herein in its entirety by reference, discloses a golf ball coated with an outer layer comprising a 3:1 to 1:3 mixture of a UVA, preferably a benzotriazole UVA, and a HALS plus a fluorescent whitener (FWA). Ionomers and unspecified urethane resins are exemplified.

U.S. Pat. No. 6,530,849, incorporated herein in its entirety by reference, discloses a golf ball coated with an outer layer comprising a polyurethane elastomer prepared from an aromatic isocyanurate and a benzotriazole UVA.

U.S. Pat. No. 6,949,595, incorporated herein in its entirety by reference, discloses a multilayered golf ball coated with an outer layer which comprises a polyurethane resin, which may be aromatic, a benzotriazole UVA and a HALS. No particular amounts or ratios of the light stabilizers are disclosed.

U.S. Pat. No. 7,001,952, incorporated herein in its entirety by reference, discloses coating compositions containing polyurethane dispersions and highly crosslinked polymer particles which may be stabilized with UVAs and HALS.

Co pending application Ser. No. 11/521,331, filed Sep. 14, 2006, incorporated herein in its entirety by reference, discloses polyurethane compositions, in particular thermoplastic polyurethanes, with good color fastness comprising a combination of an ultraviolet light absorber and a compound containing at least one nitroxyl. However, incorporation of a nitroxyl in a high enough concentration to be effective in an aromatic polyurethane generates an unacceptable amount of initial color and therefore is not always usable.

Co pending application Ser. No. 11/630,230, filed Dec. 20, 2006, incorporated herein in its entirety by reference, discloses polyurethane compositions containing either a specific HALS compound, i.e., n-butyl-(3,5-di-t-butyl-4-hydroxybenzyl) bis-(1,2,2,6-pentamethyl-4-piperidinyl) malonate, and/or an oxanilide UVA.

While it is known to add a mixtures of UVAs and HALS to polyurethanes, it has been found that adding a mixture of certain benzotriazole UVAs/HALS in a weight ratio of from about 1:1 to about 91:1 UVA:HALS, for example, about 2:1 to about 19:1, for example about 3.3:1 to about 19:1 UVA:HALS, to an aromatic polyurethane provides surprisingly good results in terms of reducing or slowing discoloration of the aromatic polyurethane. Additional components such as FWAs may be present, as in U.S. Pat. Nos. 5,840,788 and 5,1556,405, but are not necessary to achieve good results.

### DESCRIPTION OF THE INVENTION

Provided is an aromatic polyurethane composition comprising an aromatic polyurethane and from about 0.01 to about 30% by weight of a stabilizing mixture, based on the weight of the aromatic polyurethane composition, which stabilizing mixture comprises
a hydroxyphenyl benzotriazole ultraviolet light absorber and
a hindered amine light stabilizer which comprises a compound containing a 2,2,6,6-tetramethylpiperidine moiety substituted on the nitrogen at the 1 position by hydrogen, alkyl, alkoxy, acyl, or alkyl or alkoxy substituted by hydroxyl, or carboxylic ester

in a weight ratio of ultraviolet light absorber: hindered amine light stabilizer of from about 1:1 to about 19:1, for example a weight ratio of about 2:1 to about 19:1, for example about 4:1 to about 19:1, wherein the stabilizing composition is present in an amount effective so that the aromatic polyurethane composition exhibits after 24 hours exposure in a QUV test chamber equipped with UVA-340 lamps a delta E change in color of less than 1 as measured by CIE L*A*B* color measuring equipment and wherein the aromatic polyurethane composition is free of, i.e., does not contain, either n-butyl-(3,5-di-t-butyl-4-hydroxybenzyl) bis-(1,2,2,6-pentamethyl-4-piperidinyl) malonate or an oxanilide UVA.

The benzotriazole UVA in the stabilizing mixture is therefore present in an amount that is approximately equal to or greater than that of the HALS. For example, effective approximate weight ratios of UVA to HALS include 1:1, 2:1, 3:1, 4:1, 5:1, 6:1, 7:1, 8:1, 9:1, 10:1, 15:1, 19:1 and fractional values in between such as 1.5:1 and 3.3:1 etc.

Benzotriazole UVAs are well known and one or more than one may be present. Many commercial benzotriazole UVAs have the general structure of, for example, formula I: 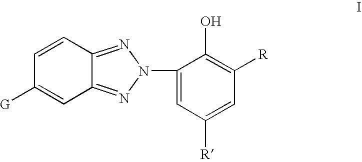
where, G is hydrogen, halogen or other substituent and R and R′ are alkyl, aryl, aralkyl, substituted alkyl etc. Such compounds are ubiquitous throughout the literature.

A useful subset of formula I include benzotriazole UVAs of general formula II 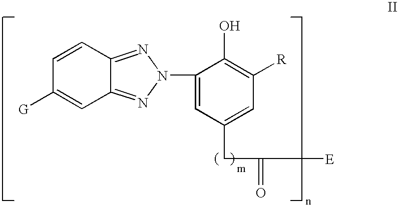
wherein, for example, m is 0, 1 or 2, typically m is 1 or 2, often m is 2; n is 1 or 2, G is hydrogen or halogen, R is alkyl, for example straight or branched chain C₁-C₂₄alkyl,
and when n is 1,
E is OE′ wherein E′ is hydrogen, straight or branched chain C₁-C₂₄alkyl which is uninterrupted or interrupted by one or more oxygen atoms, and which can also be unsubstituted or substituted by —OH, —OCO-alkenyl, —OCO-alkyl, or glycidyl;
and when n is 2,
E is —O-E″-O— wherein E″ is straight or branched chain C₁-C₂₄alkylene which is uninterrupted or interrupted by one or more oxygen atoms, and which can also be unsubstituted or substituted by —OH, —OCO-alkenyl, —OCO-alkyl, or glycidyl.

For example, excellent results are achieved when the benzotriazole UVA of the stabilizing mixture comprises a compound of formula II wherein,

m is 2, n is 1 or 2, G is H or Cl, R is tert-butyl,

when n is 1 E is —(OCH₂CH₂)_{w}OH or —(OCH₂CH₂)_{w}O C₁-C₁₂alkyl,

when n is 2 E is —(OCH₂CH₂)_{w}O—,

and w is 1 to 12.

For example, the benzotriazole UVA of the stabilizing mixture comprises a compound of formula II, wherein m is 2, G is H, n is 1 and E is —(OCH₂CH₂)₈OH, and/or a compound of formula II, wherein m is 2, G is H, n is 2 and E is —(OCH₂CH₂)₈O—.

In particular, excellent results are obtained when the benzotriazole UVA of the stabilizing mixture comprises 2-(3-t-butyl-2-hydroxy-5-(2-(ω-hydroxy octa(ethyleneoxy)carbonyl ethyl)phenyl)-2H-benzotriazole. For Example, the benzotriazole UVA of the stabilizing mixture is itself a mixture which includes 2-(3-t-butyl-2-hydroxy-5-(2-(ω-hydroxy octa(ethyleneoxy)carbonyl ethyl)phenyl)-2H-benzotriazole, for example, the benzotriazole UVA of the stabilizing mixture comprises the transesterification products of 2-(3-tert-butyl-2-hydroxy-5-(2-methoxycarbonylethyl)phenyl)-2H-benzotriazole with polyethylene glycol 300. In such mixtures, compounds of formula II where n is 1 and n is 2 are present as are small amounts of residual reactants such as polyethylene glycol.

In some cases, the presence of a glycol, such as a polyethylene glycol, can further augment the reduction of yellowing in aromatic polyurethane; however, the presence of large amounts of a polyglycol can cause compatibility problems leading to, for example, exudation, unacceptable appearance etc.

A wide variety of hindered amine light stabilizers (HALS) are known and commercially available and one or more than one HALS may be used. Examples of such compounds are listed herein below and the references already cited. In the present invention, the HALS component is typically a derivative of 2,2,6,6-tetramethylpiperidine substituted on the nitrogen at the 1 position by hydrogen, alkyl, alkoxy or acyl. The substituent on the ring nitrogen may also be substituted, for example, alkyl or alkoxy substituted by hydroxyl or carboxylic ester.

Examples of commercially available HALS useful as part of the stabilizing mixture include N,N′-1,6-hexanediylbis{N-(2,2,6,6-tetramethyl-4-piperidinyl)-formamide}; dimethyl succinate polymer with 4-hydroxy-2,2,6,6-tetra-methyl-1-piperidine ethanol; bis-(1,2,2,6,6-pentamethyl-4-piperidinyl)sebacate; 3-dodecyl-1-(2,2,6,6-tetramethyl-4-piperidyl-pyrrolidin)-2,5-dione; poly-methylpropyl-3-oxy-[4(2,2,6,6-tetramethyl)piperidinyl]siloxane; bis-(1,2,2,6,6-pentamethyl-4-piperidinyl)-sebacate; bis-(1-octyloxy-2,2,6,6,tetramethyl-4-piperidinyl)sebacate; and bis-(2,2,6,6-tetramethyl-4-piperidinyl) sebacate.

For example, the HALS of the stabilizing mixture comprises bis-(1,2,2,6,6-pentamethyl-4-piperidinyl)sebacate; methyl (1,2,2,6,6-tetramethyl-4-piperidinyl)sebacate; bis-(1-octyloxy-2,2,6,6,tetramethyl-4-piperidinyl)sebacate or bis-(2,2,6,6-tetramethyl-4-piperidinyl)sebacate.

In particular, excellent results are obtained when the benzotriazole UVA of the stabilizing mixture comprises 2-(3-t-butyl-2-hydroxy-5-(2-(ω-hydroxy octa(ethyleneoxy)carbonyl ethyl)phenyl)-2H-benzotriazole, for example a mixture which includes the transesterification products of 2-(3-tert-butyl-2-hydroxy-5-(2-methoxycarbonylethyl)phenyl)-2H-benzotriazole with polyethylene glycol 300; and the HALS comprises bis(1,2,2,6,6-pentamethyl-4-piperidyl)sebacate, for example, the HALS is a mixture of bis(1,2,2,6,6-pentamethyl-4-piperidyl)sebacate and methyl, 1,2,2,6,6-pentamethyl-4-piperidyl sebacate.

Aromatic polyurethanes are polymers formed from the reaction of one or more aromatic isocyanate and/or aromatic isocyanurate with one or more diol and/or polyol, are widely known in the art and are common items of commerce. Examples of aromatic polyurethanes and monomers used to make aromatic polyurethanes can be found, for example, in U.S. Pat. No. 6,949,595.

For example, an aromatic polyurethane that is useful in the present invention includes the reaction product of an aromatic polyisocyanate, at least one polyol, and at least one curing agent. Any aromatic polyisocyanate available to one of ordinary skill in the art is suitable for use according to the invention. Exemplary polyisocyanates include, but are not limited to, 4,4′-diphenylmethane diisocyanate (MDI), polymeric MDI, carbodiimide-modified liquid MDI, p-phenylene diisocyanate (PPDI), m-phenylene diisocyanate (MPDI), toluene diisocyanate (TDI), 3,3′-dimethyl-4,4′-biphenylene diisocyanate (TODI), naphthalene diisocyanate (NDI); xylene diisocyanate (XDI); p-tetramethylxylene diisocyanate (p-TMXDI); m-tetramethylxylene diisocyanate (m-TMXDI); tetracene diisocyanate, naphthalene diisocyanate, anthracene diisocyanate, and mixtures thereof.

Polyisocyanates are known to those of ordinary skill in the art as having more than one isocyanate group, e.g., di-, tri-, and tetra-isocyanate. Frequently, the polyisocyanate includes MDI, PPDI, TDI, or a mixture thereof. The term “MDI” includes 4,4′-diphenylmethane diisocyanate, polymeric MDI, carbodiimide-modified liquid MDI, and mixtures thereof.

The present aromatic polyurethane compositions include thermoplastic, elastomeric and thermoset polyurethanes, exist in any processed form including a sheet, plaque, pellet, other molded article, fiber, film, powder, coating formulation etc.

Thermoplastic aromatic polyurethane (TPU) compositions are known and descriptions thereof can be found in, for example, U.S. Pat. Nos. 5,908,894; 5,785,916; 5,780,573; 5,254,641; 5,173,543, the references therein and in a myriad of technical and commercial publications. Unlike thermoset polyurethanes, thermoplastic polyurethanes are processed in a manner similar to other thermoplastic polymers in operations such as extrusion, injection molding, wire coating, etc. Typical processing temperatures of TPUs can reach 380° F. to 420° F. (up to 240° C.).

Non-thermoplastic polyurethanes, including elastomeric or thermoset polyurethanes, for example, foams, coatings, cast or injection molded articles etc, are usually not subjected to the rigorous processing conditions encountered with TPU. Frequently, non-thermoplastic urethanes are formed during the processing step as in, for example, cast or injection molding where the urethane polymer is produced in the mold directly yielding an article with a selected shape, or in the curing of a polyurethane coating where either the aromatic isocyanate reacts with a polyol upon application or where a polyurethane polymer is crosslinked upon application. However, there are instances where elastomeric and even cross linked polyurethanes are subjected to further processing. Molded urethane articles are also frequently heated after initial formation, either in the mold or without.

The aromatic polyurethane compositions of the present invention may be comprised by a layer of a multilayered object, for example, the aromatic polyurethane composition may be a coating or film which adheres to an article, or the aromatic polyurethane composition may be a shaped article, such as a fiber, sheet, other molded article or a film to which a coating or film adheres. The preparation and application of polyurethane coatings are well known in the art.

When the present aromatic polyurethane compositions are comprised by a coating formulation, the coating formulation can be applied to any desired substrate, for example metal, wood, plastic, composite, glass or ceramic material substrates, by customary methods, for example, brushing, spraying, pouring, draw down, spin coating, dipping etc.

For example, excellent results are achieved by incorporating the stabilizing mixture of the invention into a dispersion of an aromatic polyurethane resin in a carrier such as an organic solvent and/or water to produce a coating formulation which is then applied to an article and cured or dried.

The present aromatic polyurethane compositions may be applied as a melt of to the surface of an existing article. For example, a multi-layered article comprising the present aromatic polyurethane compositions as a layer may be obtained by coextrusion to form a sheet or other molded article or a sheathed fiber.

The aromatic polyurethane compositions of the present invention have many useful any applications, one example being leather or faux leather compositions comprising the present compositions, in particular, the use of the present compositions in the leather or faux leather coating industry.

One particular embodiment of the invention relates to aromatic polyurethane coatings, for example, protective coatings for faux leather.

In any aromatic polyurethane composition of this invention, other common components may also be present, such as the organic solvent mentioned above. Further, the aromatic polyurethane compositions of the instant invention will typically contain other common additives which include antioxidants, other light stabilizers, phosphites or phosphonites, benzofuran-2-ones, thiosynergists, polyamide stabilizers, metal stearates, nucleating agents, fillers, reinforcing agents, lubricants, emulsifiers, dyes, pigments, dispersants, optical brighteners, flame retardants, antistatic agents, blowing agents, plasticizers, pigments, dyes, other optical brighteners, rheology additives, catalysts, flow-control agents, slip agents, crosslinking agents, crosslinking boosters, halogen scavengers and the like or mixtures thereof.

Specific examples of common polymer additives can be found in co-pending application Ser. No. 11/521,331, already included by reference.

For example, the polyurethane compositions may also contain one or more phenolic antioxidants, phosphites, hydroxylamines, surfactants, organic solvents, dispersants, colorants, fluorescent whiteners, processing aids, other stabilizers and the like.

One embodiment of the invention therefore relates to an aromatic polyurethane composition, which in addition to the mixture of UVA and HALS, additional components selected from dyes, pigments, phenolic antioxidants, phosphites, hydroxylamines, surfactants and organic solvents are present. For example solvents selected from the group consisting of alcohols, glycols, poly-alkyleneglycols, amides, esters, ketones, aliphatic hydrocarbons and aromatic hydrocarbons may be present.

One particular embodiment of the invention relates to an aromatic polyurethane composition which comprises in addition to the UVA and HALS, at least one additional compound selected from the group consisting of titanium dioxide, glycols and poly-alkyleneglycols.

The UVAs and HALS of the invention may be added either during the formation of the polymer, that is during the polymerization reaction referred to above, or during processing of an already formed polyurethane resin.

The UVAs and HALS are incorporated by using standard techniques, where required at elevated temperature. The UVA and HALS can be added together or separately. For example, the UVA and HALS are incorporated via extrusion, blending, emulsification, solution casting, brabender mixing, injection molding compression molding or other molding process, dissolution, dispersion, calendaring, grinding, dry mixing etc.

In preparing the compositions of this invention, it is possible within the scope of the invention to add the UVA and HALS to a polyol or isocyanate precursor of a polyurethane, however, the UVA and HALS are typically added to a urethane polymer, although polyols and/or isocyanates may be additionally present.

For example, the UVA and HALS are blended with an aromatic thermoplastic polyurethane resin and other optional additives and to create a mixture which is extruded at elevated temperatures, for example, the extrusion is carried out at temperatures between 140° C. and 250° C.; for example the extrusion is carried out at temperatures between 160° C. and 240° C.; for example the extrusion is carried out at temperatures between 170° C. and 220° C.

For example, the UVA and HALS are blended with an aromatic thermoplastic polyurethane resin and other optional additives and to create a mixture which is dispersed in a carrier to create a coating composition.

The aromatic urethane polymer of the present composition may be further polymerized by reaction with additional polyol or isocyanate, or reacted with formaldehyde or other chain extenders to form longer polymer chains, or cross linked with traditional cross linking agents.

Known benzotriazole UVAs include for example known commercial hydroxyphenyl-2H-benzotriazoles and benzotriazoles as disclosed in, U.S. Pat. Nos. 3,004,896; 3,055,896; 3,072,585; 3,074,910; 3,189,615; 3,218,332; 3,230,194; 4,127,586; 4,226,763; 4,275,004; 4,278,589; 4,315,848; 4,347,180; 4,383,863; 4,675,352; 4,681,905, 4,853,471; 5,268,450; 5,278,314; 5,280,124; 5,319,091; 5,410,071; 5,436,349; 5,516,914; 5,554,760; 5,563,242; 5,574,166; 5,607,987 and 5,977,219, such as 2-(2-hydroxy-5-methylphenyl)-2H-benzotriazole, 2-(3,5-di-t-butyl-2-hydroxyphenyl)-2H-benzotriazole, 2-(2-hydroxy-5-t-butylphenyl)-2H-benzotriazole, 2-(2-hydroxy-5-t-octylphenyl)-2H-benzotriazole, 5-chloro-2-(3,5-di-t-butyl-2-hydroxyphenyl)-2H-benzotriazole, 5-chloro-2-(3-t-butyl-2-hydroxy-5-methylphenyl)-2H-benzotriazole, 2-(3-sec-butyl-5-t-butyl-2-hydroxyphenyl)-2H-benzotriazole, 2-(2-hydroxy-4-octyloxyphenyl)-2H-benzotriazole, 2-(3,5-di-t-amyl-2-hydroxyphenyl)-2H-benzotriazole, 2-(3,5-bis-α-cumyl-2-hydroxyphenyl)-2H-benzotriazole, 2-(3-t-butyl-2-hydroxy-5-(2-(ω-hydroxy-octa-(ethyleneoxy)carbonyl-ethyl)-, phenyl)-2H-benzotriazole, 2-(3-dodecyl-2-hydroxy-5-methylphenyl)-2H-benzotriazole, 2-(3-t-butyl-2-hydroxy-5-(2-octyloxycarbonyl)ethylphenyl)-2H-benzotriazole, dodecylated 2-(2-hydroxy-5-methylphenyl)-2H-benzotriazole, 2-(3-t-butyl-2-hydroxy-5-(2-octyloxycarbonylethyl)phenyl)-5-chloro-2H-benzotriazole, 2-(3-tert-butyl-5-(2-(2-ethylhexyloxy)-carbonylethyl)-2-hydroxyphenyl)-5-chloro-2H-benzotriazole, 2-(3-t-butyl-2-hydroxy-5-(2-methoxycarbonylethyl)phenyl)-5-chloro-2H-benzotriazole, 2-(3-t-butyl-2-hydroxy-5-(2-methoxycarbonylethyl)phenyl)-2H-benzotriazole, 2-(3-t-butyl-5-(2-(2-ethylhexyloxy)carbonylethyl)-2-hydroxyphenyl)-2H-benzotriazole, 2-(3-t-butyl-2-hydroxy-5-(2-isooctyloxycarbonylethyl)phenyl-2H-benzotriazole, 2,2′-methylene-bis(4-t-octyl-(6-2H-benzotriazol-2-yl)phenol), 2-(2-hydroxy-3-α-cumyl-5-t-octylphenyl)-2H-benzotriazole, 2-(2-hydroxy-3-t-octyl-5-α-cumylphenyl)-2H-benzotriazole, 5-fluoro-2-(2-hydroxy-3,5-di-α-cumylphenyl)-2H-benzotriazole, 5-chloro-2-(2-hydroxy-3,5-di-α-cumylphenyl)-2H-benzotriazole, 5-chloro-2-(2-hydroxy-3-α-cumyl-5-t-octylphenyl)-2H-benzotriazole, 2-(3-t-butyl-2-hydroxy-5-(2-isooctyloxycarbonylethyl)phenyl)-5-chloro-2H-benzotriazole, 5-trifluoromethyl-2-(2-hydroxy-3-α-cumyl-5-t-octylphenyl)-2H-benzotriazole, 5-trifluoromethyl-2-(2-hydroxy-5-t-octylphenyl)-2H-benzotriazole, 5-trifluoromethyl-2-(2-hydroxy-3,5-di-t-octylphenyl)-2H-benzotriazole, methyl 3-(5-trifluoromethyl-2H-benzo-triazol-2-yl)-5-t-butyl-4-hydroxyhydrocinnamate, 5-butylsulfonyl-2-(2-hydroxy-3-α-cumyl-5-t-octylphenyl)-2H-benzotriazole, 5-trifluoromethyl-2-(2-hydroxy-3-α-cumyl-5-t-butyl-phenyl)-2H-benzotriazole, 5-trifluoromethyl-2-(2-hydroxy-3,5-di-t-butylphenyl)-2H-benzo-triazole, 5-trifluoromethyl-2-(2-hydroxy-3,5-di-α-cumylphenyl)-2H-benzotriazole, 5-butylsulfonyl-2-(2-hydroxy-3,5-di-t-butylphenyl)-2H-benzotriazole and 5-phenylsulfonyl-2-(2-hydroxy-3,5-di-t-butylphenyl)-2H-benzotriazole.

Known HALS include, for example 4-hydroxy-2,2,6,6-tetramethylpiperidine, 1-allyl-4-hydroxy-2,2,6,6-tetramethylpiperidine, 1-benzyl-4-hydroxy-2,2,6,6-tetramethylpiperidine, bis(2,2,6,6-tetramethyl-4-piperidyl)sebacate, bis(2,2,6,6-tetramethyl-4-piperidyl) succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl) nitrilotriacetate, tetrakis-(2,2,6,6-tetramethyl-4-piperidyl)-1,2,3,4-butane-tetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, 3-n-octyl-7,7,9,9-tetramethyl-1,3,8-triazaspiro[4.5]decan-2,4-dione, bis(1-octyloxy-2,2,6,6-tetramethylpiperidyl)sebacate, bis(1-octyloxy-2,2,6,6-tetramethylpiperidyl) succinate, linear or cyclic condensates of N,N′-bis-(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis-(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidin-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensation product of N,N′-bis(2,2,6,6-tetramethyl-4-piperidyl)hexamethylenediamine and 4-cyclohexylamino-2,6-dichloro-1,3,5-triazine, a condensation product of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); N-(2,2,6,6-tetramethyl-4-piperidyl)-n-dodecylsuccinimid, N-(1,2,2,6,6-pentamethyl-4-piperidyl)-n-dodecylsuccinimid, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, diester of 4-methoxy-methylene-malonic acid with 1,2,2,6,6-pentamethyl-4-hydroxypiperidine, poly[methylpropyl-3-oxy-4-(2,2,6,6-tetramethyl-4-piperidyl)]siloxane, reaction product of maleic acid anhydride-α-olefin-copolymer with 2,2,6,6-tetramethyl-4-aminopiperidine or 1,2,2,6,6-pentamethyl-4-aminopiperidine.

Also known are sterically hindered amines substituted on the N-atom by a hydroxy-substituted alkoxy group, for example compounds such as 1-(2-hydroxy-2-methylpropoxy)-4-octadecanoyloxy-2,2,6,6-tetramethylpiperidine, 1-(2-hydroxy-2-methylpropoxy)-4-hexadecanoyloxy-2,2,6,6-tetramethylpiperidine, the reaction product of 1-oxyl-4-hydroxy-2,2,6,6-tetramethylpiperidine with a carbon radical from t-amylalcohol, 1-(2-hydroxy-2-methylpropoxy)-4-hydroxy-2,2,6,6-tetramethylpiperidine, 1-(2-hydroxy-2-methylpropoxy)-4-oxo-2,2,6,6-tetramethylpiperidine, bis(1-(2-hydroxy-2-methylpropoxy)-2,2,6,6-tetramethylpiperidin-4-yl)sebacate, bis(1-(2-hydroxy-2-methylpropoxy)-2,2,6,6-tetramethylpiperidin-4-yl) adipate, bis(1-(2-hydroxy-2-methylpropoxy)-2,2,6,6-tetramethylpiperidin-4-yl) succinate, bis(1-(2-hydroxy-2-methylpropoxy)-2,2,6,6-tetramethylpiperidin-4-yl) glutarate and 2,4-bis{N-[1-(2-hydroxy-2-methylpropoxy)-2,2,6,6-tetramethylpiperidin-4-yl]-N-butylamino}-6-(2-hydroxyethyl-amino)-s-triazine.

Colorants, e.g., dyes and pigments which may be present in the aromatic polyurethane compositions of the instant invention include organic and inorganic colorants including titanium dioxide and carbon black. Excellent results are obtained with compositions containing titanium dioxide.

The term “effective amount” or “amount effective” in reference to the additives is that amount that results in the desired effect regarding color fastness. In determining the optimum effective amount of UVA and HALS or other optional additives, it is necessary to take into account all the factors that impact the color change of polyurethane composition. For example, the initial color and the rate at which different aromatic polyurethanes discolor vary. The rate of color change will also depend on factors including the types of other additives present, processing conditions and conditions of use etc. The optimum concentration for the UVA and HALS may also depend on the thickness and clarity of the aromatic polyurethane article ultimately produced. However, determining the most beneficial amount UVA and HALS will require no more experimentation as is common these applications.

Typically, the total amount of the UVA and HALS mixture is present in an amount from about 0.01 to about 30 weight %, for example about 0.1 to about 15 weight %, for example about 0.1 to about 6 weight % based on the weight of the aromatic polyurethane composition. When used in a coating formulation, the weight % of the UVA and HALS mixture is based on the weight of the dried solids.

When the UVA/HALS mixture of this invention is incorporated into aromatic polyurethane resins as found in for example molded articles, coatings and films the articles, coating and films are protected from discoloration, more specifically, yellowing when exposed to UV light.

Excellent results have been achieved with aromatic polyurethane coatings and UVA/HALS compositions that are liquid. That is either each of the UVA and HALS is liquid or the composition together is liquid as in mixing a liquid UVA and a HALS that is soluble in the UVA.

When preparing a the stabilizing mixture comprising the UVA and HALS of the present invention, it has been found that the presence of organic solvents are useful in providing a readily handled liquid composition.

In one particular embodiment of the invention, a composition comprising a mixture of a commercially available benzotriazole, TINUVIN 1130 which is sold and used herein as a mixture of the transesterification products of 2-[3-tert-butyl-2-hydroxy-5-(2-methoxy carbonylethyl)phenyl]-2H-benzotriazole with polyethylene glycol 300 and a small amount of a glycol oligomer, was shown to be particularly effective when incorporated into an aromatic polyurethane coating. In this case the glycol allows for a more free flowing liquid and may allow for better incorporation into the coating. While it can not be said why the presence of glycol, being a diluent and therefore reducing the UV absorption of the UVA would not also dilute the effectiveness of the UVA, it appears that organic solvents are not detrimental to the stabilizing efficiency of the invention and can even be helpful.

One embodiment of the invention therefore relates to an aromatic polyurethane composition which comprises a stabilizing composition comprising a UVA and a HALS and an organic solvent such as alcohols, glycols, poly-alkyleneglycols, amides, esters, ketones, aliphatic hydrocarbons or aromatic hydrocarbons, for example, glycols or poly-alkyleneglycols.

Both the UVA and HALS must be present in the specified ratios. These products individually are not as effective in preventing yellowing of the aromatic polyurethane, but together are very effective in preventing the yellowing of, for example, a coating or film comprising an aromatic polyurethane.

Also provided herein is a method for improving the color fastness of aromatic polyurethane compositions to light exposure, which method comprises the addition of an effective amount of the UVA/HALS mixture described above, wherein the aromatic polyurethane composition exhibits a change in color as measured by delta E of less than 1 after 24 hours exposure in a QUV test chamber equipped with UVA-340 lamps.

Also provided is a method for improving the improving the color fastness of commercial compositions and articles by incorporating into or applying thereon a composition comprising an aromatic polyurethane composition of the present invention.

For example, a method is provided for improving the color fastness a faux leather composition which method comprises preparing the aromatic polyurethane composition according to the method of claim 16 and applying a composition containing the aromatic polyurethane composition obtained to a faux leather composition.

### EXAMPLES

The following non-limiting examples illustrate the invention. All parts, percentages and ratios herein refer to parts, percentages and ratios based on weight.

The following general procedure is used to prepare and expose to UV light aromatic polyurethane test films.

The stabilizer composition is added to 3.0 grams of a commercial polyurethane dispersion in a 23×85 mm vial with screw thread and the mixture vigorously shaken by hand until the ingredients are uniformly mixed. The resulting formulation is drawn down on a clear polyester panel (P300-7C from The LENETA COMPANY) with a 0.00075 BIRD applicator from BYK GARDNER COMPANY. The film is allowed to dry in air for 3 hours then dried in a convection oven at 130° C. for 30 minutes.

The dried film is exposed in a QUV test chamber equipped with UVA-340 lamps at 40° C. for 24 hours after which time the change in color relative to the unexposed dried film is determined by visual inspection and/or Delta E is measure by a MINOLTA SPECTROPHOTOMETER CM-3600d using standard methods.
UVA 1—transesterification product of 2-[3-tert-butyl-2-hydroxy-5-(2-methoxycarbonyl ethyl)phenyl]-2H-benzotriazole with polyethylene glycol 300,
UVA 2—2-(3-tert-butyl-2-hydroxy-5-(2-octyloxycarbonylethyl)phenyl)-2H-benzotriazole,
UVA 3—2-(3-dodecyl-5-methyl-2-hydroxyphenyl)-2H-benzotriazole,
UVA 4—2-hydroxyphenyl-1,3,5-triazine UVA
HALS 1—mixture of (Bis(1,2,2,6,6-pentamethyl-4-piperidyl)sebacate and Methyl 1,2,2,6,6-pentamethyl-4-piperidyl sebacate)
HALS 2—bis(1-octyloxy-2,2,6,6-tetramethylpiperidin-4-yl)sebacate,

The following table lists results after QUV exposure as determined by visual examination of compositions containing the stabilizer mixture shown. In each sample, 0.15 grams of a mixture of UVA and HALS is added to 3 grams of polyurethane.

| Example | Stabilizer Composition | Color After UV Exposure |
|---|---|---|
| 1(blank) | No Stabilizer | very yellow |
| 2 | UVA 1 | slightly yellow |
| 3 | HALS 1 | moderately yellow |
| 4 | 67% UVA 1 and 33% HALS 1 | clear water white |
| 5 | HALS 2 | strongly yellow |
| 6 | 50% UVA 2 and 50% HALS 2 | moderately yellow |
| 7 | 33% UVA 2 and 67% HALS 2 | moderately yellow |
| 8 | 100% UVA 4 | very yellow |
| 9 | 80% UVA 1 and 20% HALS 1 | clear water white |
| 10 | 67% UVA 3 and 33% HALS 1 | little to no yellowing |

Examples 4, 9 and 10 exhibit almost no yellowing.

The following table lists results after QUV exposure as determined by delta E of films comprising a commercial aromatic polyurethane, titanium dioxide and a 5% loading of a mixture of UVA 1:HALS 1 in the ratio shown.

| Example | Stabilizer Ratio | delta E After UV Exposure |
|---|---|---|
| 11(blank) | No Stabilizer | 8.12 |
| 12 | 1:99 | 2.45 |
| 13 | 1:19 | 2.07 |
| 14 | 1:4 | 1.85 |
| 15 | 1:1.4 | 1.64 |
| 16 | 1:1 | 0.95 |
| 17 | 1.4:1 | 0.65 |
| 18 | 4:1 | 0.75 |
| 19 | 19:1 | 0.67 |
| 20 | 99:1 | 1.82 |
| 21 | 2:1 | 0.71 |

Examples 16, 17, 18, 19 and 21 exhibit a delta E of less than 1.

### Example 22

A 4:1 mixture of UVA 1 and HALS 1 are dry blended with a commercial aromatic polyether-based thermoplastic polyurethane with Shore hardness ˜50 at 3% loading based on total weight of the polyurethane composition and extruded in a LEISTRITZ 27 mm twin screw extruder with a standard mixing screw. Extrusion temperatures are between 200° C. and 210° C., Barrel residence time is 1 minute. The polyurethane compositions are ground into pellets, compression molded into 2 by 2 inch, 60 mil thick plaques and exposed to UV light as above with excellent results.

What is claimed:

1. An aromatic polyurethane composition comprising an aromatic polyurethane and
from about 0.01 to about 30% by weight of a stabilizing mixture, based on the weight of the aromatic polyurethane composition, which stabilizing mixture comprises
a hydroxyphenyl benzotriazole ultraviolet light absorber
and
a hindered amine light stabilizer which comprises a compound containing a 2,2,6,6-tetramethylpiperidine moiety substituted on the nitrogen at the 1 position by hydrogen, alkyl, alkoxy, acyl, or alkyl or alkoxy substituted by hydroxyl, or carboxylic ester
in a weight ratio of ultraviolet light absorber:hindered amine light stabilizer of from about 1:1 to about 19:1,
wherein the stabilizing composition is present in an amount effective so that the aromatic polyurethane composition exhibits after 24 hours exposure in a QUV test chamber equipped with UVA-340 lamps a delta E change in color of less than 1 as measured by CIE L*A*B* color measuring equipment and wherein the aromatic polyurethane composition is free of either n-butyl-(3,5-di-t-butyl-4-hydroxybenzyl) bis-(1,2,2,6-pentamethyl-4-piperidinyl) malonate or an oxanilide UVA.

2. An aromatic polyurethane composition according to claim 1, wherein the benzotriazole UVA of the stabilizing mixture comprises a compound of formula II 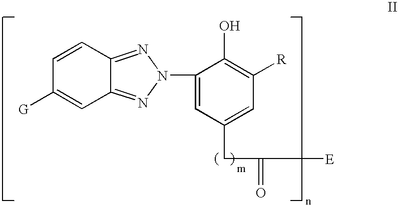
wherein m is 1 or 2, n is 1 or 2,
G is hydrogen or halogen,
R is straight or branched chain C₁-C₂₄alkyl,
and
when n is 1, E is OE′ wherein E′ is hydrogen, straight or branched chain C₁-C₂₄alkyl which alkyl is uninterrupted or interrupted by one or more oxygen atoms and/or unsubstituted or substituted by —OH, —OCO-alkenyl, —OCO-alkyl, or glycidyl;
when n is 2, E is —O-E″-O— wherein E″ is straight or branched chain C₁-C₂₄alkylene which is uninterrupted or interrupted by one or more oxygen atoms, and/or unsubstituted or substituted by —OH, —OCO-alkenyl, —OCO-alkyl, or glycidyl.

3. An aromatic polyurethane composition according to claim 2, wherein, in formula II,
m is 2, G is H or Cl, R is tert-butyl,
when n is 1, E is —(OCH₂CH₂)_{w}OH or —(OCH₂CH₂)_{w}O C₁-C₁₂alkyl;
when n is 2, E is —(OCH₂CH₂)_{w}O—,
and w is 1 to 12.

4. An aromatic polyurethane composition according to claim 3, wherein the benzotriazole UVA of the stabilizing mixture comprises
a compound of formula II, wherein G is H, n is 1 and E is —(OCH₂CH₂)₈OH and/or
a compound of formula II, wherein G is H, n is 2 and E is —(OCH₂CH₂)₈O—.

5. An aromatic polyurethane composition according to claim 1, wherein the hindered amine light stabilizer comprises a compound selected from N,N′-1,6-hexanediylbis{N-(2,2,6,6-tetramethyl-4-piperidinyl)-formamide}; dimethyl succinate polymer with 4-hydroxy-2,2,6,6-tetra-methyl-1-piperidine ethanol; bis-(1,2,2,6,6-pentamethyl-4-piperidinyl)sebacate; 3-dodecyl-1-(2,2,6,6-tetramethyl-4-piperidyl)pyrrolidin-2,5-dione; poly-methylpropyl-3-oxy-[4(2,2,6,6-tetramethyl)piperidinyl]siloxane; bis-(1-octyloxy-2,2,6,6,tetramethyl-4-piperidinyl)sebacate; n-butyl-(3,5-di-t-butyl-4-hydroxybenzyl) bis-(1,2,2,6-pentamethyl-4-piperidinyl) malonate; and bis-(2,2,6,6-tetramethyl-4-piperidinyl)sebacate.

6. An aromatic polyurethane composition according to claim 5, wherein the hindered amine light stabilizer comprises a compound selected from bis-(1,2,2,6,6-pentamethyl-4-piperidinyl)sebacate; bis-(2,2,6,6-tetramethyl-4-piperidinyl)-sebacate and bis-(1-octyloxy-2,2,6,6,tetramethyl-4-piperidinyl)sebacate.

7. An aromatic polyurethane composition according to claim 2, wherein the hindered amine light stabilizer comprises a compound selected from bis-(1,2,2,6,6-pentamethyl-4-piperidinyl)sebacate; bis-(2,2,6,6-tetramethyl-4-piperidinyl)-sebacate and bis-(1-octyloxy-2,2,6,6,tetramethyl-4-piperidinyl)sebacate.

8. An aromatic polyurethane composition according to claim 2, wherein the benzotriazole UVA of the stabilizing mixture comprises 2-(3-t-butyl-2-hydroxy-5-(2-(ω-hydroxy octa(ethyleneoxy) carbonylethyl)phenyl)-2H-benzotriazole and the hindered amine light stabilizer of the stabilizing mixture comprises bis-(1,2,2,6,6-pentamethyl-4-piperidyl) sebacate.

9. An aromatic polyurethane composition according to claim 1 which comprises at least one additional compound selected from the group consisting of phenolic antioxidants, phosphites, hydroxylamines, surfactants, titanium dioxide, water and organic solvents.

10. An aromatic polyurethane composition according to claim 1 which comprises at least one additional compound selected from the group consisting of titanium dioxide, glycols and poly-alkyleneglycols.

11. An aromatic polyurethane composition according to claim 1, wherein the weight ratio of ultraviolet light absorber:hindered amine light stabilizer is from about 3.3:1 to about 19:1.

12. An aromatic polyurethane composition according to claim 2, wherein the weight ratio of ultraviolet light absorber:hindered amine light stabilizer is from about 2:1 to about 19:1.

13. An aromatic polyurethane composition according to claim 12, wherein the weight ratio of ultraviolet light absorber:hindered amine light stabilizer is from about 3.3:1 to about 19:1.

14. An aromatic polyurethane composition according to claim 1, which is a coating or film.

15. A faux leather composition comprising an aromatic polyurethane composition according to claim 1.

16. A method for improving the color fastness of an aromatic polyurethane composition to light exposure, which method comprises adding to a composition containing an aromatic polyurethane from about 0.01 to about 30% by weight, based on the weight of the aromatic polyurethane composition, of a stabilizing mixture, which stabilizing mixture comprises
a hydroxyphenyl benzotriazole ultraviolet light absorber and
a hindered amine light stabilizer which comprises a compound containing a 2,2,6,6-tetramethylpiperidine moiety substituted on the nitrogen at the 1 position by hydrogen, alkyl, alkoxy, acyl, or alkyl or alkoxy substituted by hydroxyl, or carboxylic ester
in a weight ratio of ultraviolet light absorber:hindered amine light stabilizer of from about 1:1 to about 19:1, wherein the stabilizing composition is added in an amount effective to provide an aromatic polyurethane composition which exhibits after 24 hours exposure in a QUV test chamber equipped with UVA-340 lamps a delta E change in color of less than 1 as measured by CIE L*A*B* color measuring equipment.

17. A method according to claim 16, wherein the benzotriazole UVA of the stabilizing mixture comprises a compound of formula II 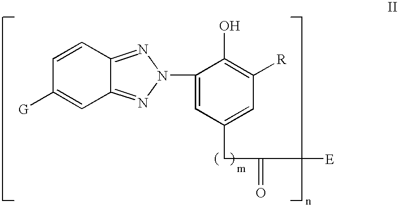
wherein m is 1 or 2, n is 1 or 2,
G is hydrogen or halogen,
R is straight or branched chain C₁-C₂₄alkyl, and
when n is 1, E is OE′ wherein E′ is hydrogen, straight or branched chain C₁-C₂₄alkyl which alkyl is uninterrupted or interrupted by one or more oxygen atoms and/or unsubstituted or substituted by —OH, —OCO-alkenyl, —OCO-alkyl, or glycidyl;
and
when n is 2, E is —O-E″-O— wherein E″ is straight or branched chain C₁-C₂₄alkylene which is uninterrupted or interrupted by one or more oxygen atoms, and/or unsubstituted or substituted by —OH, —OCO-alkenyl, —OCO-alkyl, or glycidyl.

18. A method according to claim 16, wherein the stabilizing mixture comprises a hydroxyphenyl benzotriazole ultraviolet light absorber and a hindered amine light stabilizer in a weight ratio of from about 3.3:1 to about 19:1

19. A method according to claim 17, wherein the stabilizing mixture comprises a hydroxyphenyl benzotriazole ultraviolet light absorber and a hindered amine light stabilizer in a weight ratio of from about 2:1 to about 19:1 and the hindered amine light stabilizer comprises a compound selected from bis-(1,2,2,6,6-pentamethyl-4-piperidinyl) sebacate; bis-(2,2,6,6-tetramethyl-4-piperidinyl)-sebacate and bis-(1-octyloxy-2,2,6,6,tetramethyl-4-piperidinyl)sebacate.

20. A method which comprises preparing the aromatic polyurethane composition according to the method of claim 16 and applying a composition containing the aromatic polyurethane composition obtained to a faux leather composition.
